(19) United States
(12) Patent Application Publication
(10) Pub. No.: US 2008/0282080 A1
(43) Pub. Date: Nov. 13, 2008

(54) Method and apparatus for adapting a communication network according to information provided by a trusted client

(75) Inventors: Arn Hyndman, Ottawa (CA); Nicholas Sauriol, Kanata (CA)

Correspondence Address: Anderson Gorecki & Manaras, LLP;Attn: John C. Gorecki, P.O BOX 553, CARLISLE, MA, 01741, US

(73) Assignee: Nortel Networks Limited, St. Laurent (CA)

(21) Appl. No.: 12/152,086

(22) Filed: May 12, 2008

Related U.S. Application Data
(60) Provisional application No. 60/917,484, filed on May 11, 2007.

(51) Int. Cl. H04L 9/32; H04L 9/00

(52) U.S. Cl. 713/150; 726/1; 726/3

(57) ABSTRACT

Hosts connecting to the network implement an adaptive networks client that monitors other applications on the host and provides information to an adaptive networks server to provide information about traffic being generated by the host. The client may also capture information about the user, host, access type, and other information of interest. The information provided by the adaptive network client may allow the network to adapt to the user, the device, the application, and the protocol being used. Users and applications can be authenticated and trusted. From a network standpoint, having a trusted client associated with the host allows the same benefits as deep packet inspection, regardless of whether the traffic is encrypted, and without requiring the network elements to actually perform deep packet inspection. The administrator may also centrally apply policy to control which applications are allowed to run on the hosts.

### CROSS-REFERENCE TO RELATED APPLICATIONS

This application claims priority to U.S. Provisional Patent Application No. 60/917,484, filed May 11, 2007, the content of which is hereby incorporated herein by reference.

### BACKGROUND

1. Field

This application relates to communication networks and, more particularly, to a method and apparatus for adapting a communication network according to information provided by a trusted client.

2. Description of the Related Art

Data communication networks may include various computers, servers, nodes, routers, switches, hubs, proxies, and other devices coupled to and configured to pass data to one another. These devices will be referred to herein as “network elements,” and may provide a variety of network resources on the network. Data is communicated through data communication networks by passing protocol data units (such as packets, cells, frames, or segments) between the network elements over communication links on the network. A particular protocol data unit may be handled by multiple network elements and cross multiple communication links as it travels between its source and its destination over the network. Hosts such as computers and PDAs connect to and transmit/receive data over the communication network and, hence, are users of the communication services offered by the communication network.

Many applications may be run on hosts connected to the network, and a network operator may wish to provide differential access to the applications based on the type of application, the ID of the host, who is running the application, and numerous other factors. To allow the network operator to determine which traffic belongs to which application or host, a process commonly referred to as “deep packet inspection” may be used by a network element to try to figure out what type of traffic is being carried by a particular packet. Deep packet inspection allows policy, shaping, load sharing, etc., to be applied to higher level protocols such as HTTP, SOAP, SNMP, and other protocols to thereby allow the network operator to perform advanced services or provide enhanced quality of service levels to particular types of traffic.

There are several problems with relying on deep packet inspection. One of the problems is speed. As the speed at which networks transmit data has increased, the amount of time a particular network element has to process packets of data has decreased. Thus, it may be challenging to implement deep packet inspection where the packets are to be processed in real time. A second problem is encryption. When the packet contains encrypted data, the network element will not be able to determine anything about the packet other than unencrypted information in the packet header. In some encryption schemes, even parts of the header information may be encrypted, which results in the network elements on the network only really being able to determine the end-point addresses of the encrypted flows. While not all data is encrypted, the trend is increasingly to use encryption to protect data as it is transmitted across the network. Moreover, not only good data is encrypted—the rogue data that a network element may wish to filter out is also likely to be encrypted.

Since encryption prevents deep packet inspection, and deep packet inspection is necessary to implement differential treatment of particular types of flows on the network, it would be desirable to provide a different way of providing network elements with information associated with traffic flowing through the network so that the network elements could provide advanced services such as traffic shaping, firewalls, and other value added services even when the packets containing that data are encrypted.

### SUMMARY OF THE DISCLOSURE

Hosts connecting to the network implement an adaptive networks client that monitors other applications on the host and provides information to an adaptive networks server to provide information about traffic being generated by the host. The client may also capture information about the user, host, access type, and other information of interest. The information provided by the adaptive network client may allow the network to adapt to the user, the device, the application, and the protocol being used. Users and applications can be authenticated and trusted. From a network standpoint, having a trusted client associated with the host allows the same benefits as deep packet inspection, regardless of whether the traffic is encrypted, and without requiring the network elements to actually perform deep packet inspection. The administrator may also centrally apply policy to control which applications are allowed to run on the hosts.

### BRIEF DESCRIPTION OF THE DRAWINGS

Aspects of the present invention are pointed out with particularity in the claims. The following drawings disclose one or more embodiments for purposes of illustration only and are not intended to limit the scope of the invention. In the following drawings, like references indicate similar elements. For purposes of clarity, not every element may be labeled in every figure. In the figures:

FIG. 1 is a functional block diagram of an example of a communication network according to an embodiment of the invention;

FIG. 2 is a flow diagram illustrating a process implemented by an adaptive networks client according to an embodiment of the invention;

FIG. 3 is a flow diagram illustrating a process implemented by an adaptive networks server according to an embodiment of the invention;

FIG. 4 is a functional block diagram of a host containing an adaptive networks client according to embodiments of the invention; and

FIG. 5 is a functional block diagram of a network element implementing an adaptive networks server according to embodiments of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

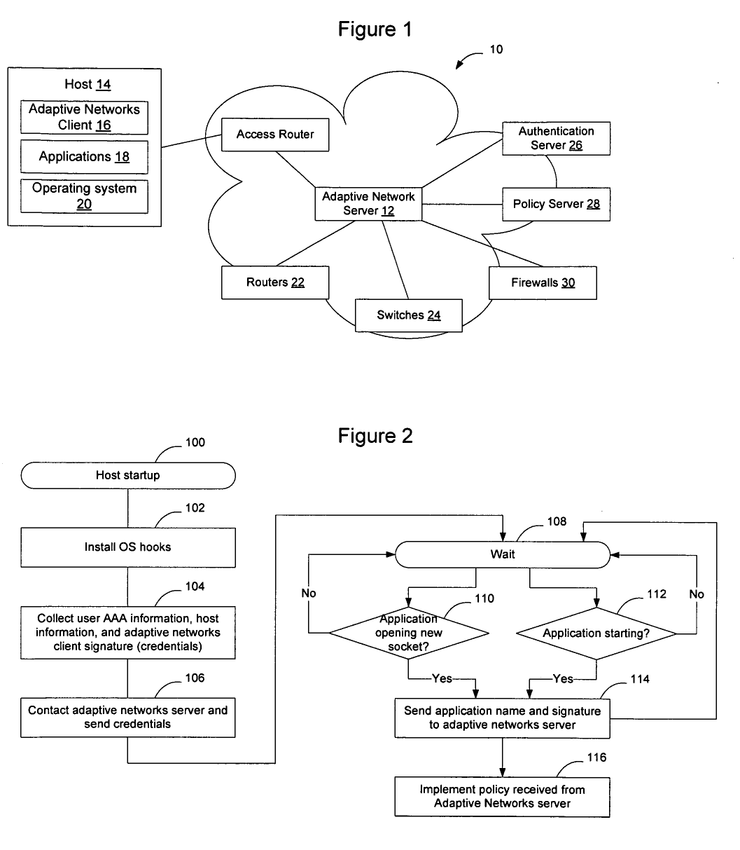

FIG. 1 illustrates an example communication network 10 in which an adaptive networks server 12 is used to interface with an adaptive networks client 16 on an end-user machine (host 14), to allow information about applications 18 being run on the host 14 to be provided to the adaptive networks server 12. The information received by the adaptive networks server 12 may be used by the server 12 to adjust the manner in which routers 22, switches 24, and other devices on the network handle traffic associated with the host 14 and the priority with which the network elements provide service to the host 14. For example, the adaptive networks server may interface with the switches, routers, and other network devices on the network 10 to adjust the quality of service parameters or other aspects of the service provided to the host 14 in connection with particular flows of traffic associated with the applications 18 running on the host. The adaptive networks server may also prohibit particular application s from running on the host or block access to the network from particular applications or hosts.

The adaptive networks client may collect many different types of information about the user of the host, applications being run on the host hardware, and the hardware itself, that may be conveyed to the adaptive networks server. Upon receipt, the adaptive networks server may instruct the adaptive networks client to interact with the host operating system to disable the application and/or to take actions on the network to adapt the network to the host's particular needs to provide enhanced quality of service, filtering, etc.

According to an embodiment of the invention, an adaptive networks client 16 is instantiated on the host 14. The adaptive networks client collects application signatures as applications are created on the host 14 and/or when the applications attempt to access the network. The adaptive networks client hooks into the host operating system 20 so that no application changes are required to the applications running on the host. By collecting application signatures, the adaptive networks client may supply the adaptive networks server with information about the application that is being used to access the network. Other information associated with the application, such as the application name, the application path, a signature of the application, and dynamic link library list associated with the application may also be collected by the adaptive networks client and passed to the adaptive networks server.

The adaptive networks client may also provide information about the type of client device that is being used to access the network and the identity of the network user. The identity of the user may be obtained by requiring the user to enter credentials to the adaptive network client or may be obtained from other credentials entered by the applicant in connection with another login process, such as when the user logs into the operating system. Adding the application data to these other pieces of data allows the adaptive networks server to more clearly determine the known good traffic from the known bad traffic and from the unknown traffic. It also allows the network administrator to easily lock down the network and adapt to new application demands. By deploying clients widely on hosts having access to an enterprise network, the administrator may effectively block particular applications from having access to the network to thereby prevent attacks on the network before they are initiated.

Enabling the administrator to have control over which applications are run on hosts on the network is advantageous from another perspective as well. Specifically, the administrator may make a policy decision one time for a particular type of application, and have that policy decision passed to the adaptive networks server. Policy decisions and other types of policy related information may be stored in a policy server 28 which may be associated with a network management station to enable the network administrator to set policy on the network. When the trusted clients determine that the application has started, the trusted clients will forward that event information to the adaptive networks server. If the administrator has specified that the application should not be allowed to run on the network, the adaptive networks server may block network access to the host or to the traffic from that application. By enabling the adaptive networks server to control access to the network on a per-application basis, the administrator may make a centralized decision to not allow access to particular applications and effectively prevent those applications from being run on all hosts on the network. By allowing the decision making process to be performed by the network administrator rather than each individual network user, the decision may be made by an expert rather than having each end user try to discern whether to allow particular applications to run on their hosts. Where the administrator decides to allow the application to run on hosts on the network, the administrator may also specify network parameters to be applied to traffic from the application, such as quality of service, etc.

The adaptive network client may be implemented as software. Optionally, the adaptive network client may be integrated into another program on the host such as a personal firewall software program running on the host or in an Antivirus program running on the host. Conventionally, a security program such as an antivirus program may monitor applications to determine when a program is seeking network access and prompt the user when a suspicious program attempts to access the network. The same type of monitoring technology may be used to monitor applications and collect information about programs as they attempt to connect to the network. However, rather than block access to the network or prompt the user for authorization for a particular application to have access to the network, the adaptive networks client collects information about the application, the user, and the host, and transmits the information to the adaptive networks server to allow the adaptive networks server to learn more about the type of information being transmitted by the host so that the adaptive networks server may adjust the operational parameters of the network to accommodate the host's network traffic.

The adaptive network client installs hooks into the operating system to monitor application start operations and network access. The same hooks as personal firewalls may be used for this purpose. Windows monitoring hooks for networking access are available at the Network Application Program Interface (API), the Transport Data Interface (TDI), the Network Protocol Layer, the Network Driver Interface Specification (NDIS) driver layer, and possibly at other locations depending on the type of host and operating system. The NDIS hooking driver in particular may provide good coverage of network access events. For operating systems other than Windows, other hooks may be used. For example, SocketFilter/NetFilter hooks may be used for Linux. Firewall hook such as etherLib/PFIL_HOOKS may be used for Apple a operating systems AIX/BSD/OS X. Solaris packet filtering hooks may also be used.

The adaptive network client will extract the user's credentials from the operating system or authenticate the user directly, such as by prompting for the user's ID and password. Once the adaptive network client has collected this information, it will send the user's credentials and application data, such as the application name and signature, to the adaptive networks server. Communications between the client and the adaptive networks server are preferably secured, e.g. by encrypting the communications using SSL or another type of encryption process. Securing the communication between the clients and adaptive networks server prevent other network users from tampering with the communications to ensure that the adaptive networks server can trust the communications from the client. The adaptive network client may sign applications via a MD5 hash or other code signing mechanism. The client may also be protected against tampering by using techniques such as obfuscation, ring O, and other known techniques.

The adaptive networks server may be a stand-alone server or may be instantiated as a process in another network server. The server software optionally may be bundled with hardware to form an adaptive network appliance such as a router/switch that is configured to handle data traffic on the network.

The adaptive networks server should be deployed such that it has access to configure network devices, such as switches/routers, that will be used to handle data on the network so that it can enforce policy set by a network administrator. Specifically, the adaptive networks server collects the data from the user, and based on policy set for the network, determines which traffic should be allowed to be transmitted on the network and which should be blocked. Additionally, the adaptive networks server may set priority levels of different traffic and perform other actions to direct how the network should handle the traffic. To allow these decisions to be implemented in the network, the adaptive networks server is preferentially deployed to have access to configure the network devices that will be handling the traffic from the hosts associated with the adaptive networks clients being serviced by the adaptive networks server.

Upon receipt of the user's credentials and application data, the adaptive networks server will validate the user's credentials against an authentication server 26. In connection with this, the adaptive networks server may act as a RADIUS proxy for the client to interface with a RADIUS server to determine if the user is authorized to access the network. The adaptive networks server may also implement a RADIUS server, rather than a RADIUS proxy, to directly authenticate the client.

If the client is authenticated, the adaptive networks server 12 uses the user and application data provided by the adaptive networks client 16 to determine, from a policy server 28, how the network access attempt should be handled by the adaptive networks server. Policy engines are well known in the art and, accordingly, will not be described in greater detail herein. An example policy may be something like [user]+[application]+[conditions]+[attributes]=allowed/denied, where user=userID of a unique user (which could be a real person or a system or process ID); application=the unique name and version of a signed and approved application; conditions=any conditions that can be applied such as time of day, source address, etc.; and attributes=description of the type of service to be provided such as quality of service including capacity, latency, priority, security, etc.

After the adaptive networks server determines the policy to be applied to a particular host/application, the policy for the flow will be applied to the network. This may be performed in any number of ways, for example by opening/closing one or more ports in firewalls, adjusting the quality of service provided to the flow such as by adjusting the bandwidth allocated to the flow, latency qualities of the flow, security associated with the flow, adjusting parameters in the routers and switches that will handle the flow to allow the flow to be afforded a particular quality of service, etc. Many different ways of adjusting one or more parameters of the network may be implemented to effect the policy on the network.

Optionally, to prevent users from circumventing use of the adaptive network client, a default policy of no-access may be set such that, where the adaptive networks server is not able to authenticate the user or no application signature data is provided from the adaptive networks client, the adaptive networks server will enforce a “no access” policy to prevent the host 14 from accessing the network. Thus, maintaining a valid adaptive network client may be a prerequisite to obtaining network access, to thereby deter users from tampering or removing the adaptive networks clients from their end devices. Alternate types of network access may be implemented as well, such as only allowing the host access to the public Internet and not allowing internal access to the corporate network, etc. The particular type of access to be provided and, hence the actions to be taken in connection with particular types of traffic, may be set by policy.

The adaptive networks client may run on a large number of hardware devices, such as mobile phones, PDAs, and other handheld electronic devices. The adaptive networks clients may also run on computers, laptop computers, palmtop computers, notebooks, notepads, and other types of computer devices that are configured to obtain network access. Adaptive network clients may also run in many different types of server environments, such as servers available from SUN, IBM, HP, and other server manufacturers. The adaptive networks clients may obtain hooks into many different operating systems, such as Windows, Linux, Unix, and other commonly utilized operating systems.

Other types of adaptive network clients may be used in other contexts as well. For example, a web container client may be used to monitor Internet-based applications with Tomcat, JBOSS, WAAS, etc. Similarly, a client may be hosted within a browser to monitor the plug-ins loaded in the browser environment and to provide information to the network as to the activity of the plug-ins within the browser session.

Although in the previous description the client was described as being associated with a particular host, the adaptive networks client may also be free of any host and attach to a particular session as it is created by a service on the Internet. Thus, a temporary adaptive networks client may be deployed in connection with establishment of a session between an application server and an application client to download the temporary adaptive networks client to run in connection with the application client so that the application client may be monitored for the duration of the session. Upon termination of the session, the adaptive networks client may be terminated or may remain to continue to provide information about the user that was engaged in the session.

The adaptive network server may be used in many different ways. Several examples of applications of the adaptive network service will be described. The invention is not limited to these particular applications, but rather these examples are intended to illustrate examples of how the techniques described herein may be applied to allow the network to adapt to the needs/preferences of a particular user.

For example, the adaptive networks client may detect when an application needs to talk to a business server, and automatically launch a VPN if required. The adaptive networks client could also detect which network PC has connected to the network and adjust the IM/presence settings accordingly. The adaptive networks client may collect data about bandwidth availability, based on access network quality, and provide the bandwidth availability data to the applications running on the host. The adaptive networks client may also provide an API to other applications which want to adapt to changing network conditions.

The adaptive networks client may operate proactively or predictively to interact with the adaptive networks server 12 to allocate resources on the network and otherwise configure the network for the application based on previous historical needs. For example, the client may track the history of an application's network usage (for specific user) and use the historical information to instruct the adaptive networks server to configure the network optimally for the application's anticipated usage before the flow is initiated. The adaptive networks client, in this instance, may detect the application launch and pre-configure the network for that application so that the network is ready for the flow of traffic from the application.

The client may also operate reflectively to the network availability to allow operation of the client machine to be determined or influenced at least in part based on the network conditions. In this example, the adaptive networks server sends information to the adaptive networks client indicating that the network is experiencing high/low bandwidth availability or that the network is predicted to have high/low availability based on historical data. Based on these network triggers or other similar network triggers, the adaptive networks client may start/stop processes within the host 14. For example, the client may be configured to cause a backup process to be instantiated/execute when the network is indicated to be highly available, or to pause when the network is experiencing congestion. Additionally, having a client interfacing between the adaptive networks server and applications on the host may provide a mechanism for the network to provide feedback to the applications as to the state of the network. This may allow the network to provide a signal or other indication to the applications when the network is experiencing low usage to solicit traffic from the applications. Alternatively, an API on the client may be provided to allow the applications to query as to the availability of the network.

Allowing the applications to query the client would allow an application with a bandwidth intensive use to launch during a period of relatively lower network usage to thereby flatten out network usage. As an example, assume that an e-mail program has a large e-mail to send with an attachment that exceeds a particular threshold (such as 2 Mb). The e-mail application may access the adaptive networks client to determine the current usage of the network. The adaptive networks client may cause the e-mail application to hold off transmitting the e-mail with the large attachment while the network is experiencing high demand so that the peak usage of the network may be flattened by causing the application to transmit the data during a period of other than high demand.

Many variations of the interaction between the adaptive networks client and the application may be envisioned. In the e-mail example provided above, the application may poll the adaptive networks client to determine if it should send the e-mail or wait a while. Where the adaptive networks client instructs the application to wait, the application may solicit input from the user to determine if the e-mail is urgent or not. This may be implemented in the form of a dialog box or other type of user interface. If the user indicates that the e-mail is urgent the application may override the adaptive networks client's recommendation to wait before transmitting the e-mail.

Thus, as described in this example, the adaptive networks client is not relegated to operating as a passive monitoring program, but may also interact with the applications if desired to allow the applications to obtain information as to the state of the network and to allow the network to provide information to the applications. This allows the network to assert a hold-off signal to the applications to attempt to stop the applications from transmitting data onto the network as well as allows the network to convey to the applications that there is bandwidth available to enable the applications to selectively transmit data during those periods where the network has sufficient capacity to accommodate the traffic.

The client may also be used to detect known and unknown viruses via signatures. Detecting viruses via the adaptive networks client allows new remediation possibilities, such as targeting specific client and version instead of protocol, and pushing out patches or antivirus updates to affected clients. Additionally, the adaptive networks client may help repair affected machines by monitoring the changes that have been made on the machine. Specifically, the adaptive networks client may maintain a log of changes that were made by a suspect application such as a potential virus to enable the machine to be stopped and to then revert to an operating configuration that was in effect before the changes were made by the suspect application.

Network feedback may be important in a context such as that envisioned by IEEE 802.21 which allows handoff to occur between wireless and wireline networks implemented using many different standards. For example, in an 802.21 compliant network, a user may have an IEEE 802.3 interface to a wired network. The user may undock from the network and continue to have connectivity by performing a handover from the 802.3 network to an IEEE 802.11 wireless network. As the user leaves the building, a further handover may occur from the 802.11 wireless network to an IEEE 802.16 wireless network. IEEE 802.21 allows the network device to select which network should be used and to perform a handover to that network. The client described herein may receive information from the network and provide the mobility server with information about the network to help the mobility server on the client machine more accurately select the best possible radio and encryption scheme given the current network conditions.

In the previous several examples, the adaptive networks client was described as having been installed in a conventional manner on a network device such as a computer, handheld electronic device, etc. In other embodiments, the client may be implemented in different ways. For example, the adaptive networks client may be installed on a USB key, fob, or other device and connected to the host. Alternatively, the adaptive networks client may be installed on a network element such as on the access router and operated as a proxy adaptive networks client for a number of devices that are themselves not able to implement the adaptive networks client for one reason or another.

For example, the client may be implemented in an external proxy device that is connected directly to a device that is to be controlled, e.g. by plugging the external proxy adaptive networks client into a USB port on the device. The proxy, in this example, may be implemented as a key and plugged into the device's USB port or into an Ethernet port, and allow traffic to and/or from the device to be routed through the proxy. The user's credentials and application profiles may be downloaded to the proxy so that the client is resident in the proxy rather than the device. The proxy allows network traffic to pass through the proxy, but the client on the proxy allows code signing and other features described above to be provided in connection with the applications that are running on the device. In this way, the proxy containing the client may allow similar services to be provided for devices that are not able to support the client described above. Optionally, the proxy may have a features such that if one of the Ethernet connections is disconnected from the Proxy, the device will forget its credentials and no longer vouch for the credentials of the device.

Where the adaptive networks client is provided in a proxy such as a USB plug-in, the adaptive networks client won't be able to hook into the host operating system. Thus, in this instance, the adaptive networks proxy won't be able to collect as much data about the applications running on the host. In this instance, since the profile provided by the adaptive networks client is less detailed, the adaptive networks server may restrict network access to match an expected profile for the host.

Optionally, where the adaptive networks client is implemented as a plug-in adaptive networks proxy, the proxy may perform deep packet inspection to learn about the traffic that is being generated by the host. This has the disadvantages of conventional deep packet inspection, but is able to be done in a distributed fashion. Characterizing information associated with the traffic may then be provided by the adaptive networks client to the adaptive networks server to enable the adaptive networks server to implement rules on the network based on the traffic without requiring the network elements on the network to perform the deep packet inspection themselves. Thus, in one embodiment, the adaptive networks client or adaptive networks proxy may perform deep packet inspection on traffic before it enters the network and provide the results of the deep packet inspection to the adaptive networks server, which may then pass the results to the network elements that will be handling the data on the network that need to act on the flow.

The adaptive networks client may also reside in a wireless access point and provide the services described above that are provided by the adaptive networks client on behalf of user equipment connecting to the wireless access point. In this embodiment the user would enter its credentials into the user equipment in a standard way so that modification of the user equipment is not required nor is modification of the user's interaction with the user equipment.

The wireless access point, however, includes an adaptive networks proxy that may be used to learn about traffic from the user equipment and interact with the adaptive networks server to allow the network to adapt to the needs of the user equipment. Commonly, in a wireless network, the wireless link may be encrypted to allow the wireless signal between the user equipment and wireless access point to be secured. Commonly the wireless access point will decrypt the signals and then re-encrypt the signals into a VPN tunnel or other secure mechanism for transportation across the network. The adaptive networks proxy may perform deep packet inspection of the traffic at this point, while it is unencrypted, to determine what type of traffic is coming from the user equipment so that the adaptive networks server may be informed of the type of traffic and, hence, the network services are required to be provided to the user equipment.

The adaptive networks proxy may also receive the user's credentials and interrogate the device to discover applications in use on the user equipment. The adaptive networks proxy passes along the device credentials when the device accesses the wireless network through the wireless access device, to thereby allow the network to obtain access to the device credentials without requiring the device to implement the adaptive networks client. Thus, other devices may proxy the adaptive networks client on behalf of the device, particularly where the device itself is not able to implement the adaptive networks client. This allows the wireless proxy to perform Network Admission Control (NAC) and selectively only admit wireless devices to the network that have provided the adaptive networks client with their credentials.

The client may be used in other contexts as well. For example, when a person visits a company it is common to provide the user with a temporary badge that will allow the person to access the company facilities. The person may also be issued a key that is able to plug into a port of the person's host, such as into a USB port of a person's laptop computer, to be used to identify the host on the company's wireless network. The key, according to one embodiment, contains an adaptive networks client that contains the credentials of the user and interacts with the adaptive networks server on the network to control the actions the user is able to take on the company network. The company's network may be set up such that a wireless networking device without the client is not allowed access to the network. By providing the user with a key containing an adaptive networks client, the user may be provided with temporary access to the wireless network in the company while the user is working at the company. Since the company controls the client, the extent of network access may be circumscribed, however, so that the amount of the company's network that is visible and available to the individual may be controlled. The client may be designed to self destruct if tampered with, after a particular period of time such as after one day, or if removed out of range of the wireless network e.g. via signal loss detection.

FIG. 2 shows an example process that may be used when a host 14 is started. As shown in FIG. 2, at startup (100) the adaptive networks client 16 will install hooks into the operating system (102) to allow the adaptive networks client to monitor the actions taken by the host. These hooks allow the adaptive networks client to notify the adaptive networks server when applications are launched so that the adaptive networks server may start to interact with network elements on the network 10 to modify the performance of the network in anticipation of the needs of the host 14, or in reaction to determined needs of the host 14.

The adaptive networks client will also collect user and host credentials (104) which the adaptive networks client will provide to the adaptive networks server (106). As part of this process, the adaptive networks client may optionally transmit a code uniquely identifying that adaptive networks client. The identity of the adaptive networks client or the type of adaptive networks client in use by the host may itself provide information to the adaptive networks server about the host 14 and the level of service to be provided to traffic associated with the host that is associated with that adaptive networks client. Providing information about the adaptive networks client itself allows the adaptive networks server to learn the capabilities of the adaptive networks client, such as the type and quantity of data the adaptive networks client is able to collect. For example, a client in a wireless access point may not be able to collect as much data as a client hooked into the operating system of a computer. Additionally, the type/version of the adaptive networks client may allow the adaptive networks server to determine if the client is up to date and also may help the server determine whether the client has been compromised.

Once the initiation process has completed, the adaptive networks client will wait for an application to open a new socket 110, for an application to start 112, or for other events that would result in network traffic. Upon occurrence of one of these events, the name of the application and optionally the signature of the application may be sent to the adaptive networks server to enable the adaptive networks server to adjust the network for the impending traffic. The adaptive networks client may also review instructions from the adaptive networks server (116) based on policy to be implemented on the network, to allow the adaptive networks server to effect some level of control over the adaptive networks client and, hence, over the host.

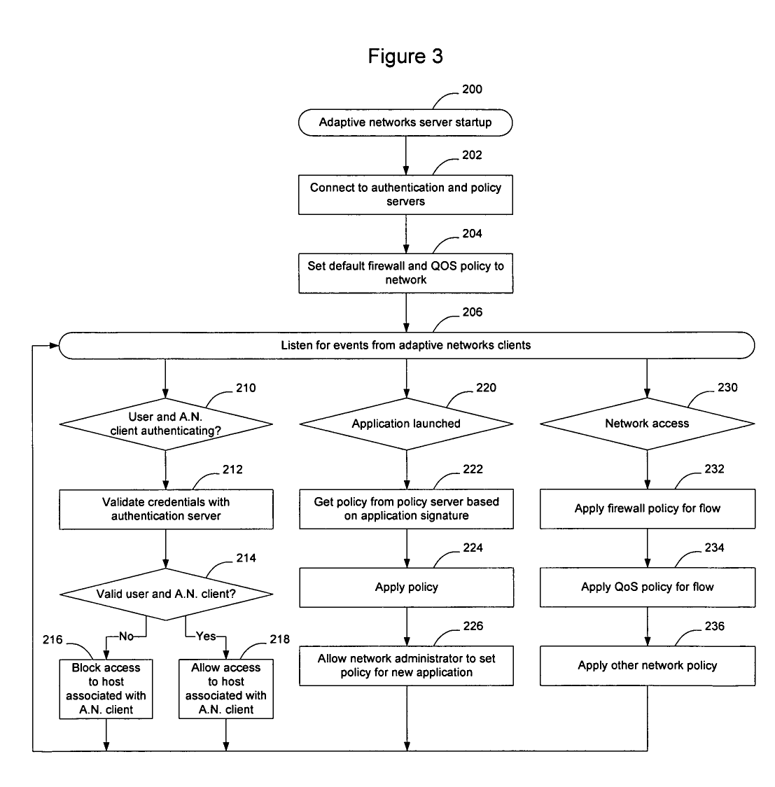

FIG. 3 shows an example process that may be implemented by an adaptive networks server. As shown in FIG. 3, at startup (200) the adaptive networks server will connect to an authentication server and policy server (202) to allow it to authenticate users and determine policy associated with the users and applications that may be running by hosts on the network. Where one or more of these servers is implemented by the adaptive networks server, those servers will be started and initiated as part of the startup process. The adaptive networks server will also set default firewall, quality of service policy, and other types of policy on the network (204).

The adaptive networks server will then listen for events from adaptive networks clients (206). As discussed above, there are many types of events that may occur that may implicate the adaptive networks server. Only several of the possible events have been shown in FIG. 3 since the adaptive networks server may also implement other functions in addition to those shown in FIG. 3.

In the example shown in FIG. 3, a user and an adaptive networks client may authenticate with the adaptive networks server (210). In this instance, the adaptive networks server will validate the credentials provided by the adaptive networks client with the authentication server (212).

If user and adaptive networks client credentials are validated, the adaptive networks server will allow access to the host associated with the adaptive networks client (218). Otherwise, the adaptive networks server may block access to the host (216). As another alternative, the adaptive networks server may allow the host to have access to the public network access only. Thus, for example where the host is connected to a corporate intranet, the adaptive networks server may allow the host to have access to the Internet over the corporate network, but not to perform any additional actions on the network or access any additional resources available on the corporate network. Other actions may be implemented by the adaptive networks server as well.

If the adaptive networks server detects that an application has been launched (220) it will get policy from the policy server based on the application's signature (222). The adaptive network server will use the policy for the application to determine the needs of the application and apply the policy to the network to configure the network for the application (224). For example, if the application is a VPN client that has been launched on the host, the adaptive networks server may access the policy server to determine the quality of service and bandwidth parameters that are to be provided to the VPN client by the network, and interface with the network elements on the network to cause that quality of service to be provided to the VPN client. Where the application is not recognized or the policy server doesn't have policy for the particular application, the network administrator may be asked to make a decision with respect to the application to allow the administrator to create policy for the new application before it will be allowed to launch or before it is allowed to access the network.

If the adaptive networks server detects a network access (230), the adaptive networks server may access the policy server to determine how a firewall should handle the network access (232) and what type of quality of service should be provided (234). Where there are other network policies to be applied, the adaptive networks server will retrieve those policies as well and cause them to be implemented on the network (236).

Although several events have been described in connection with FIG. 3, other events may occur as well. Thus, the adaptive networks server may listen for events and, when they occur, access the policy server to determine how the network should be configured based on the event. Some of the events described herein that are detected by the adaptive networks client and conveyed to the adaptive networks server are authorized events. In this instance, the adaptive networks server will determine from the AAA server and policy server that the events are authorized and apply policy to allow the network to be modified to facilitate those events. In other instances, the adaptive networks server will determine that the event is not authorized or otherwise not favored by the network operator. In this event, the policy may dictate that the event be terminated by the adaptive networks client or that the network be configured to either prevent access or to reduce the quality of service provided to the host.

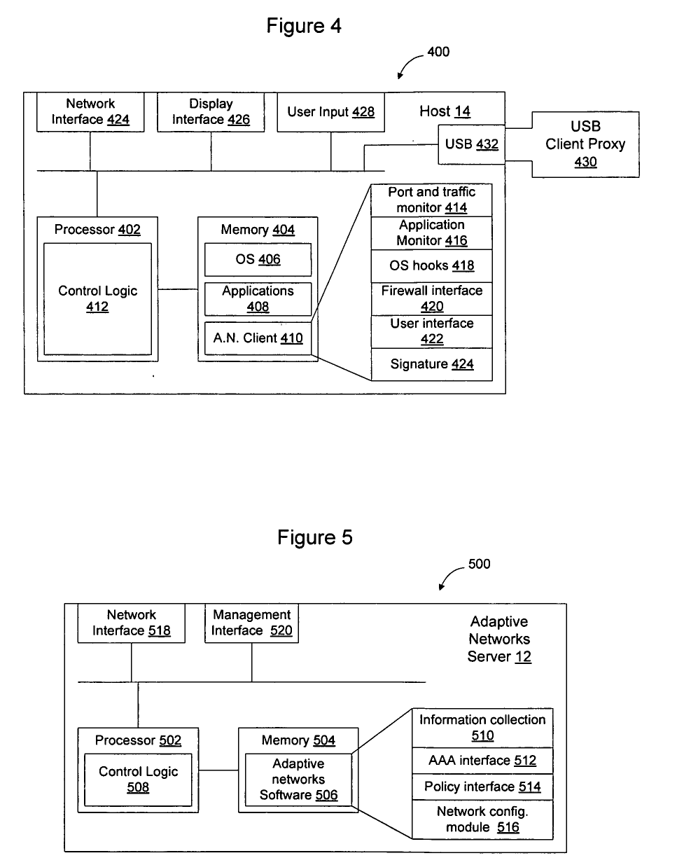

FIG. 4 shows a functional block diagram of an example of a host. As shown in FIG. 4, the host 400 includes a processor 402 and a memory 404. The memory may contain data and instructions to enable the processor 402 to implement an operating system 406, one or more applications 408, and an adaptive networks client 410. The data and instructions are loaded into the processor 402 as control logic 412 to allow the processor to be configured to implement the process described in greater detail above. The host may include other standard components as well, as would be understood by a person of ordinary skill in the art.

The adaptive networks client, in one embodiment, includes one or more functional modules that may be used to perform the functions ascribed to the adaptive networks client in greater detail above. For example, the adaptive networks client may include a functional module 414 configured to monitor when ports are opening and closing on the host and to monitor traffic on the ports. The adaptive networks client may also include a functional module configured to monitor applications 416 and a functional module to hook into the operating system 418 to learn when applications are taking action on the host and may need network access.

The adaptive networks client may include a firewall interface 420 to interact with a firewall on the host 14, network 10, or with a firewall that is installed intermediate the host 14 and the network 10, to allow the adaptive networks client to transmit data to the firewall and to receive feedback from the firewall when an application seeks to transmit data through the firewall. Optionally, the adaptive networks client may contain an user interface to allow the user of the host to input data via a user input 430 so that the user may specify, for example, the user's name and password.

Other functional modules may be included in the adaptive networks client as well to enable the adaptive networks client to perform additional functions on the host and to allow the adaptive networks client to interact with the adaptive networks server. Additionally, the adaptive networks client may be implemented in a USB key 430 connected to the host 14 via USB interface 432.

One feature of the adaptive networks client is that it is able to be trusted by the adaptive networks server. The trust relationship may be verified by the adaptive networks server by allowing the adaptive networks client to provide a software signature and ID number, or other combinations of information, that collectively allow the adaptive networks server know that the adaptive networks client has not been tampered with. For example, as shown in FIG. 4, the adaptive networks client may include a signature 424 or other information that identifies the adaptive networks client to the adaptive networks server. The signature may also allow the adaptive networks server to verify the integrity of the adaptive networks client and, optionally, the identity of the adaptive networks client.

The host may include conventional components associated with a computer or other computing device, such as a network interface 426, a display interface 428, and a user input interface 430. The particular configuration of components associated with the host 14 and the manner in which the host is implemented will depend on the particular type of computer being used to implement the host. Clients may be implemented on many different types of hosts and, accordingly, the particular configuration may vary widely depending on the particular type of computer or handheld electronic device used to implement the host. Additionally, the client may also be implemented on a USB key rather than on the host itself, as shown in greater detail in FIG. 4.

FIG. 5 shows a functional block diagram of an example adaptive networks server. As shown in FIG. 5, the adaptive networks server 500 includes a processor 502 and a memory 504. The memory may contain data and instructions to enable the processor 502 to implement adaptive networks server software 506. The data and instructions are loaded into the processor 502 as control logic 508 to allow the processor to be configured to implement the aspects of the process ascribed to the adaptive networks server that are described in greater detail above.

The adaptive networks server software 506, in one embodiment, includes one or more functional modules that may be used to perform the functions ascribed to the adaptive networks server in greater detail above. For example, the adaptive networks server software may include a functional module 510 configured to collect information from the adaptive networks clients. After collecting information, the information may be passed to an AAA server or AAA server interface 512 to allow the user, host, and adaptive networks client to be authenticated and to determine whether the user, host, and/or adaptive networks client are authorized to engage in transactions on the network.

The adaptive networks server also includes a functional module to interrogate the policy server and/or the network administrator to determine how the network should be configured based on the type of application that will be using the network, the user, the host, or based on other information made available to the adaptive networks server by the adaptive networks client. The policy interface may be to an external policy server or, where the policy portion is implemented directly by the adaptive networks server, may be implemented as an interface to a database or other information store configured to hold policy information. The policy interface may also allow the adaptive networks server to contact the network administrator when insufficient policy information is present in the policy server.

The adaptive networks server will also include a network configuration module 516 designed to allow the adaptive networks software engage in protocol exchanges with network elements such as routers and switches on the network via a network interface 518 so that the policy determined by the policy interface module may be passed to the network and caused to be implemented on the network. The network may include one or more network management systems installed on the network to control operation of the network. Optionally, the network configuration module 516 may interact directly with the network management system via a network management interface 520 to allow the adaptive networks server to provide the network management system with instructions as to how the network should be configured for anticipated traffic from an application on the host. The server may be deployed as a stand-alone server or, alternatively, may be deployed as a process running within another server or in a network element such as a switch/router.

In a corporate environment, the adaptive networks server may be controlled by an administrator that may be asked to make decisions regarding particular type of traffic on the network to enable the administrator to set policy on the network. For example, the administrator may be asked whether a particular application should be allowed to run on a particular host or to run on any host on the network. This allows decisions of this nature to be made from a centralized location rather than having decisions made by the individuals operating the host computers. For example, a personal firewall program running on a host may ask the operator whether it is OK for an application to access the Internet. By instantiating an adaptive networks client on the host, a similar prompt may be provided to the network administrator to enable the network administrator to make these types of decisions on a network-wide basis or for particular hosts on the network.

Additionally, centralizing the decision making authority with the administrator via the adaptive networks server enables the administrator to specify not only whether the application will be allowed, but also the type of network access to be provided in terms of quality of service, and other parameters able to be controlled by the adaptive networks server. The administrator may be provided with access to the adaptive networks server via the policy interface 514 and/or via the management interface 520.

Since the adaptive networks server is associated with trusted adaptive networks clients deployed on hosts that will be using the network, the adaptive networks server may learn the type of information being transmitted by the hosts without requiring the network elements on the network to perform deep packet inspection. This allows the network elements to handle the packets in a faster and more efficient manner since they do not need to inspect fields outside of the headers when making forwarding decisions. Additionally, types of advanced services such as enhanced quality of service may be provided to the packets, even where the packets are encrypted, so that the types of services commonly provided by deep packet inspection may be applied to encrypted traffic without requiring the traffic to be decrypted. Thus, security may be enhanced on the network.

Optionally, the adaptive networks client may also perform deep packet inspection to allow the traffic itself rather than the application to be monitored by the adaptive networks server in a distributed fashion. The result of the deep packet inspection may then be provided to the adaptive networks server so that the result of the deep packet inspection may be used by the network elements handling the flow of data without requiring network elements to perform the deep packet inspection. Accordingly, deep packet inspection may be performed once and the results of the deep packet inspection transmitted between network elements to enable the network elements to use the results of the deep packet inspection when operating on the traffic.

It should be understood that all functional statements made herein describing the functions to be performed by the methods of the invention may be performed by software programs implemented utilizing subroutines and other programming techniques known to those of ordinary skill in the art. Alternatively, these functions may be implemented in hardware, firmware, or a combination of hardware, software, and firmware. The invention is thus not limited to a particular implementation.

The control logic may be implemented as a set of program instructions that are stored in a computer readable memory within the network element and executed on a microprocessor. However, in this embodiment as with the previous embodiments, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

It should be understood that various changes and modifications of the embodiments shown in the drawings and described herein may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of adapting a communication network based on information obtained by a trusted client resident on a host, the method comprising the steps of:
obtaining, by an adaptive networks server, information from the trusted client resident on the host about applications running on the host; and
applying policy by the adaptive networks server to the network to adjust the network for the applications running on the host by adjusting quality of service, network security, load balancing, or routing on the network for the applications.

2. The method of claim 1, wherein the information includes at least an identification of the applications running on the host and signatures of the applications.

3. The method of claim 2, wherein the information associated with each application includes an identification of the application name, the application path, a signature of the application, and dynamic link library list associated with the application.

4. The method of claim 1, wherein the information is obtained via a secure connection between the adaptive networks server and the trusted client.

5. The method of claim 1, wherein the adaptive networks server further receives identifying information associated with a user of the application, and authenticates the user using the identifying information associated with the user of the application.

6. The method of claim 1, further comprising the step of validating the trusted client resident on the host to determine whether the trusted client has been compromised.

7. The method of claim 6, wherein the step of applying policy by the adaptive networks server comprises limiting access to the network where the trusted client has been compromised.

8. The method of claim 7, wherein the step of applying policy by the adaptive networks server comprises enabling an administrator to determine which applications are to be allowed to run on the host.

9. The method of claim 8, wherein the step of applying policy comprises enabling the administrator to selectively allow or disallow a new application when it is instantiated in a first host, and then using the decision to selectively allow or disallow the new application as it is instantiated in other hosts on the network.

10. The method of claim 9, wherein the administrator may also specify a quality of service and other parameters for the application when it is instantiated in the first host.

11. A network, comprising:
an adaptive networks server; and
a plurality of hosts implementing adaptive networks clients, the adaptive networks clients providing information to the adaptive networks server about applications running on their respective hosts;
wherein the adaptive networks server is able to validate the trusted adaptive networks clients to determine if one or more of the adaptive networks clients has been compromised, and wherein the adaptive networks server will restrict network access to any client not implementing an adaptive networks client or implementing a compromised adaptive networks client.

12. The network of claim 11, wherein the network is a corporate network, and wherein the adaptive networks server will only allow access to the Internet over the corporate network to any host not implementing an adaptive networks client or implementing a compromised adaptive networks client.

13. The network of claim 11, wherein the network is a corporate network, and wherein the adaptive networks server will deny access to the corporate network to any host not implementing an adaptive networks client or implementing a compromised adaptive networks client.

14. The network of claim 11, wherein the network is a corporate network, and wherein the adaptive networks server will notify the administrator of the attempted access to the corporate network by any host not implementing an adaptive networks client or implementing a compromised adaptive networks client, to enable the administrator to selectively allow or disallow access to the host.

15. The network of claim 11, wherein the adaptive networks server is configured to adjust one or more parameters of the network to affect policy on the network associated with particular hosts and particular applications.

16. The network of claim 11, further comprising a plurality of network elements configured to handle data traffic on the network, and wherein the adaptive networks server is configured to adjust the network elements for data traffic from particular hosts or for data traffic from particular applications implemented on the hosts.

17. The network of claim 11, wherein the adaptive networks clients monitor applications for network access attempts, and provide information about the applications that are attempting to access the network to enable the adaptive networks server to determine policy to be applied for communications on the network associated with those applications.

18. The network of claim 11, wherein the adaptive networks clients provide information associated with the applications to the adaptive networks server so that the adaptive networks server is able to determine the applications that are generating data to be transmitted on the network from particular hosts without requiring a network element on the network to perform deep packet inspection.

19. The network of claim 11, wherein the network further comprises a plurality of network elements to handle traffic on the network, and wherein at least one of the network elements is able to apply filters to traffic generated by the hosts to selectively allow traffic from particular applications running on those hosts according to instructions provided by the adaptive networks server.

20. The network of claim 19, wherein at least one of the adaptive networks clients includes an Application Programming Interface (API) that will allow the adaptive networks client to be queried by an application running on the host as to an operational state of the network.

21. The network of claim 11, wherein the adaptive networks client is implemented on a proxy device that connects to the host via a USB port.

22. A method of applying network policy to encrypted network traffic generated by a host on a network, the method comprising the steps of:
receiving information from a trusted client instantiated on the host, the trusted client being configured to monitor applications instantiated on the host and to provide information about applications that are seeking access to the network and hence likely to generate network traffic;
determining policy associated with the applications;
receiving encrypted network traffic generated by the host on the network; and
applying the policy associated with the application that is likely to have generated the network traffic without unencrypting the network traffic to determine the type of network traffic.
